(19) United States
(12) Patent Application Publication
(10) Pub. No.: US 2006/0281450 A1
(43) Pub. Date: Dec. 14, 2006

(54) Methods and apparatuses for safeguarding data

(75) Inventor: Keith L. Cocita, Santa Cruz, CA (US)

Correspondence Address: THELEN REID & PRIEST, LLP, P. O. BOX 640640, SAN JOSE, CA, 95164-0640, US

(73) Assignee: X-CYTE, Inc., a California Corporation

(21) Appl. No.: 11/441,618

(22) Filed: May 26, 2006

Related U.S. Application Data
(63) Continuation-in-part of application No. 11/112,020, filed on Apr. 21, 2005.
Application No. 11/112,020 is a continuation of application No. 10/405,348, filed on Apr. 1, 2003, now Pat. No. 7,054,624.

(51) Int. Cl. H04M 3/00

(52) U.S. Cl. 455/418

(57) ABSTRACT

Methods and apparatuses for safeguarding data stored on a digital processing system (DPS) capable of communicating with a communications system are disclosed. In accordance with one embodiment of the invention when a DPS establishes communication with a communication system, the identification of the DPS is verified and access is provided to security status information pertaining to the DPS. Based upon the security status information, one or more programs are executed on the DPS. For one embodiment of the invention, one or more memory devices of a digital processing system (DPS) may be provided with an erase means. If the DPS is lost or stolen, the user need only establish a communications link with the DPS and enter the erase code to effect erasure (or modification) of specified stored data.

### CROSS-REFERENCE TO RELATED APPLICATION

This application is a continuation-in-part application claiming priority to pending application Ser. No. 11/112,020, filed on Apr. 21, 2005, entitled “Safeguarding User Data Stored in Mobile Communications Devices,” which is a continuation application claiming priority to pending application Ser. No. 10/405,348, filed on Apr. 1, 2003, entitled “Safeguarding User Data Stored in Mobile Communications Devices,” both of which are herein incorporated by reference in their entirety.

### FIELD OF THE INVENTION

Embodiments of the invention relate generally to the field of data storage, and more specifically to methods and apparatuses employing telecommunications systems to remotely modify or erase stored data.

### BACKGROUND OF THE INVENTION

Conventional data storage devices provide mechanisms for securing stored data. Such mechanisms may include password protection or encryption of the stored data. These mechanisms provide a measure of security to a user, but are less effective and less reliable when the data storage device is susceptible to unauthorized accessed (e.g., when the device has been stolen).

Various techniques have been employed to provide to maintain the integrity of mobile communications devices, such as cell phones, that are capable of communication with a telecommunications network. For example, telecommunications networks may include user terminals, such as cell phones, which utilize a SMARTCARD which includes a SIM (subscriber identity module). The SIM's include a data storage device that contains data such as the identity of the card holder (i.e., the service subscriber), billing information, and home location. When a cell phone user places a call, the SIM communicates the unique SIM code to the network. The network checks to see if the SIM code owner is a current subscriber to the network service, often by matching the SIM code with a list of authorized SIM codes. This authentication, or matching of SIM codes generally precedes all other network communication with the cell phone.

SMARTCARDs were developed to allow cell phone activities other than simple telephone calls. The SMARTCARD can contain microprocessors for, e.g., transaction management, data encryption and user authentication. The SMARTCARD or the SIM may include subscriber entered telephone numbers and other valuable information. Theft of the phone places this valuable information in the hands of others. In fact, the loss of the phone is probably less important than the loss of the valuable information contained therein. This is especially true for the new cell phones which now access the Internet, and for cell phones coupled with handheld computing devices, which browse the Internet, store Power Point presentations, and do rudimentary word processing, as well as scheduling appointments and maintaining expense accounts.

U.S. Pat. No. 5,898,783 discloses a telecommunications network with disabling circuitry which can disable the SMARTARD of the cell phone of a particular subscriber. The disable command can permanently incapacitate the SMARTCARD by destroying the power connection for the logic circuitry, or temporarily incapacitate the logic circuitry by erasing the memory within the card. According to this patent, the numbers of stolen phones can be reported to the network and entered into a database which is searched when any cell phone requests service, and a disable command or signal returned to the cell phone if its number is in the disable database. U.S. Pat. No. 5,734,978 describes a telecommunications system having a manufacturer preset destruct code stored in each cell phone. When a subscriber reports a phone stolen, the network's base station controller initiates a destruct program, using the destruct code. The destruct code destroys the data necessary for performing the telephone functions, but not the private data.

U.S. Pat. No. 6,259,908 describes a cellular phone system in which a locking code on a particular cell phone may be erased by means of a message transmitted through the cell phone system, but may not be erased or changed using the keyboard features of that phone. This arrangement has particular usefulness in a designated cellular system with many units, such as a communications network for the fire department of a large city. To set up or reconfigure the network, the entire network must be activated and the individual units (cell phones) assigned a particular number. According to the patent, all phones on the system have a locking code to prevent theft communications on the network until all units are assigned.

These schemes are disadvantageous in that they do not effect the safeguarding of personal data stored on the communication devices, but only prevent theft of telecommunications services.

### SUMMARY

A method for safeguarding stored data is disclosed. For one embodiment of the invention a communication link between a digital processing system and a network operator digital processing system is established via a communications network. A status information pertaining to the digital processing system is then accessed. The status information is stored on the network operator digital processing system and indicates whether one or more applications should be executed. One or more applications is then executed as indicated by the status information.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a cell phone, or mobile telecommunications apparatus, and the SMARTCARD that is received therein, which cooperates with the cell phone to effect communication with a telecommunications network;

FIG. 2 illustrates a block diagram of a SMARTCARD according to the principles of the present invention;

FIG. 3 illustrates a block diagram of a telecommunications network capable of communicating with a plurality of cell phones that cooperate with a SMARTCARD to effect communication with the telecommunications network;

FIG. 4 illustrates a system in which stored data is safeguarded in accordance with one embodiment of the invention;

FIG. 5 illustrates a process in which data stored on a data storage device is safeguarded in accordance with one embodiment of the invention; and

FIG. 6 illustrates a functional block diagram of a digital processing system that may be used in accordance with one embodiment of the invention.

### DETAILED DESCRIPTION

Methods and apparatuses are disclosed for safeguarding stored information from unauthorized access. In accordance with one embodiment of the invention when a DPS establishes communication with a communication system, the identification of the DPS is verified and access is provided to security status information pertaining to the DPS. Based upon the security status information, one or more programs are executed on the DPS.

It is an object of one embodiment of the invention to safeguard the private data stored on a data storage device, by permitting the user to erase or destroy that data using an on-air signal. According to one such embodiment of the invention, one or more memory devices of a digital processing system (DPS) may be provided with an erase means. For one embodiment of the invention the erase means comprises a fuse, switch, or similar device in a disable, or erase, circuit. For one embodiment of the invention, the erase means executes an erase command on receiving an on-air erase code which matches an erase code preset by the user. If the DPS is lost or stolen, the user need only establish a communications link with the DPS and enter the erase code to effect erasure (or modification) of specified stored data.

These objects are also achieved by the method of the present invention, for safeguarding data stored in a DPS capable of communication via a communications network. For one embodiment of the invention, the DPS receives a message via the communications network. The message contains an erase code that effects the erasure of data stored in a data storage device of the DPS.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, strictures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

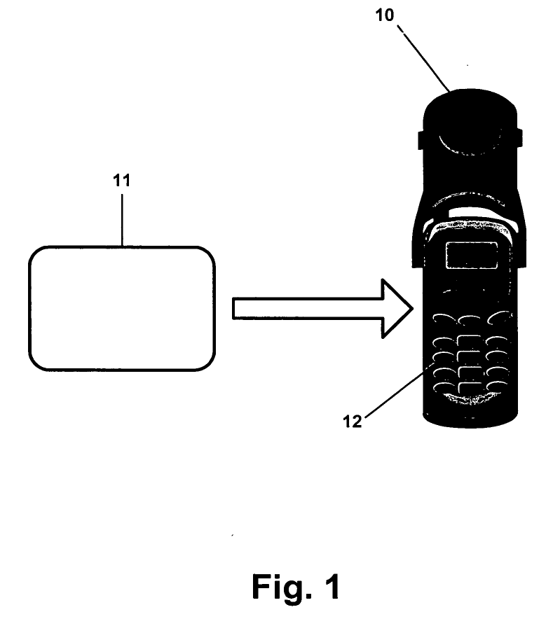

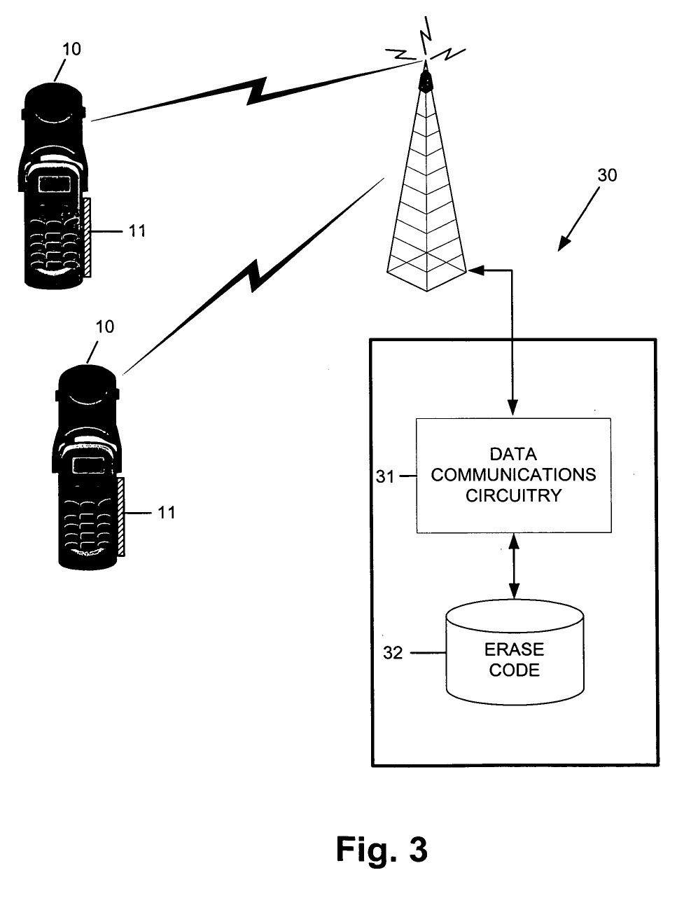

FIG. 1 illustrates a cell phone, or mobile telecommunications apparatus, and the SMARTCARD that is received therein, which cooperates with the cell phone to effect communication with a telecommunications network. As shown in FIG. 1, the cell phone 10 receives the SMARTCARD 11 which cooperates with the cell phone to effect communication with a telecommunications network, such as that illustrated in FIG. 3. The SMARTCARD, includes a SIM (subscriber identity module). The SMARTCARD identifies the user of the telecommunications system, and serves to authenticate the user as one permitted on the network. The SMARTCARD may also encrypt communications between the cell phone 10 and the telecommunications network. The alphanumeric keys, 12 of the cell phone may be used to enter information into the cell phone memory, and are the preferred means for entering the erase code.

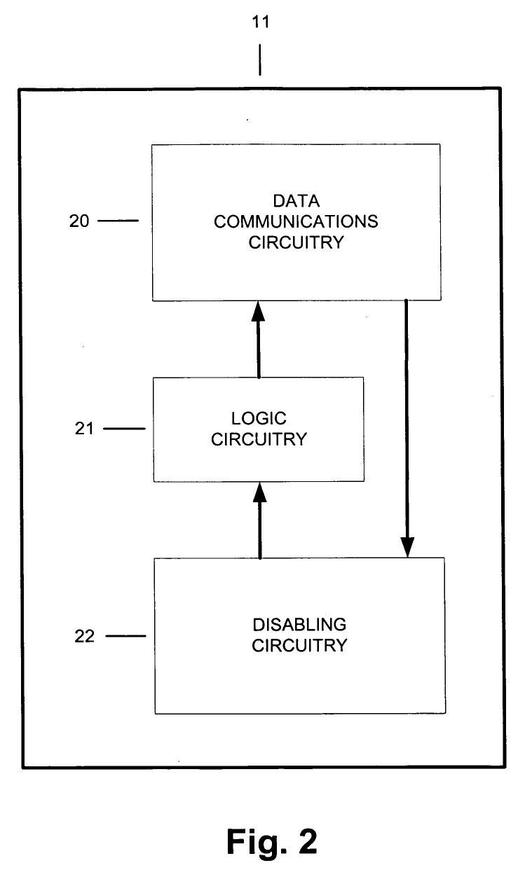

The elements of the SMARTCARD, illustrated in FIG. 2, include a data communications circuitry, a logic circuitry and a disabling, or erasing, circuitry. The data communications circuitry, 20, transmits a code uniquely identifying the SMARTCARD. The logic circuitry, 21, in the present embodiment includes data processing and storage circuitry and interconnecting circuitry, including, without limitation, a processor, memory, support circuitry, and any address, data and control buses (not shown). In one embodiment of the present invention the logic circuitry encrypts communication between the cell phone and the telecommunications network. As cell phones develop, the logic circuitry may be used to perform more and more functions, without effecting the features of the logic circuitry essential to the present invention.

The card is provided with disabling circuitry, 22, which can e.g., permanently erase the memory of the card. The disabling circuitry may comprise either a fuse or a switch, which operates to e.g. decouple the electrical power from the memory in card. Other means of effectively erasing the memory are known to those in the art, as by providing an excessive voltage that causes the memory to malfunction, even if it is still receiving power, or permanently incapacitating the logic circuitry by cutting it off from its source of power.

A block diagram of the telecommunications network is illustrated in FIG. 3. The telecommunications network, 30 is capable of communication with a plurality of cell phones 10 with cards, 11, having a subscriber identity module. Each card has a unique SIM code. Upon initiation of access to the network, the SIM code is transmitted to the network. The network, 30 has data communications circuitry, 31, to receive the SIM code. In one embodiment of the invention, the network may also include a PROM or an EEPROM for receiving and storing an erase code associated with a unique SIM code. In another embodiment of the invention, the data communications circuitry, 31, may also include an erase command.

The operation of the method and apparatus of the present invention will now be described. The user of SMARTCARD may use the alphanumeric keys, 12 to enter into, and store in the memory, an erase code to permit erasure of private data in the phone. According to a preferred embodiment of the present invention, the erase code for any selected cell phone may only be directly entered into the phone, using the keypad for that phone. The erase code may be stored in memory on the SMARTCARD, or may be transferred to, and stored on, the network. The erase code for a particular SMARTCARD or SIM may not be preset or changed by an on-air signal from a cell phone with a different SIM. The erase command may be included in the data communications circuitry of the card or on the network.

If the cell phone is stolen or lost, the user may, using another cell phone or a land line, call the telephone number of the stolen or lost cell phone, and enter the erase code. The data communications circuitry of the network and the lost phone “matches” the erase code of the on-air communication with the preset stored erase code. The “matching” may involve an exact matching of characters, or an exact mapping, requiring a specific relationship, between the preset erase code and the received erase code. If there is a match, an erase command is issued, and the private data in the stolen or lost cell phone is erased. The circuitry for executing the erase command is in the cell phone.

The present invention does not require a network database of erase codes, permitting great individual privacy. In addition, the user does not need to access disable commands on the network. No database of disabled numbers needs to be assembled and maintained by and at the network in order for the user to disable the memory for his private data. When the erase code is stored in the cell phone, it is instantly operable. In addition it may be instantly changed. The privacy of data entered into cell phones is of increasing importance. New phones incorporate Internet text messaging, e-mail, and web surfing and downloading. Elaborate negotiations may flow be conducted via a cell phone. In addition, cell phones are being combined with handheld computers and organizers, which contain word processing. Entire contracts may be recorded, transmitted, or received on a handheld apparatus including a cell phone on a telecommunications network.

Those skilled in the art should understand that while the present invention may be embodied in hardware that alternative embodiments may include software or firmware, or combinations thereof. Such embodiments may include implementations using conventional processing circuitry such as, without limitation, programmable array logic (“PAL”), digital signal processors (“DPSs”), field programmable gate array (“FPGA”), application specific integrated circuits (“ASICs”), large scale integrated circuits (“LSIs”). Moreover, the present embodiment is introduced for illustrative purposes only and other embodiments that provide a system for and method of disabling a SIM card are well within the broad scope of the present invention. Conventional computer, and processing, system architecture is more fully discussed in Computer Organization and Architecture, by William Stallings, MacMillan Publishing Co. (3rd ed. 1993). Conventional processing system network design is more fully discussed in Data Network Design, by Darren L. Spohn, McGraw-Hill, Inc. (1993). Conventional voice and data communications are more fully discussed in Data Communications Principles, by R. D. Gitlin, J. F. Hayes and S. B. Weinstein, Plenum Press (1992), The Irwin Handbook of Telecommunications, by James Harry Green, Irwin Professional Publishing (2nd ed. 1992) and Voice & Data Communications Handbook, by Regis J. Bates, Jr. and Donald Gregory, McGraw-Hill (1996). Conventional electronic circuit design is more fully discussed in The Art of Electronics, by Paul Horowitz and Winfield Hill, Cambridge University Press, (2nd ed. 1989). Conventional control systems and architectures are discussed in Modern Control Engineering by Katsuhiko Ogata, Prentice Hall 1990. Each of the foregoing publications is incorporated herein by reference.

As discussed above, embodiments of the invention are applicable in a variety of settings in which data is stored in a memory device of a DPS capable of communicating via a communications systems.

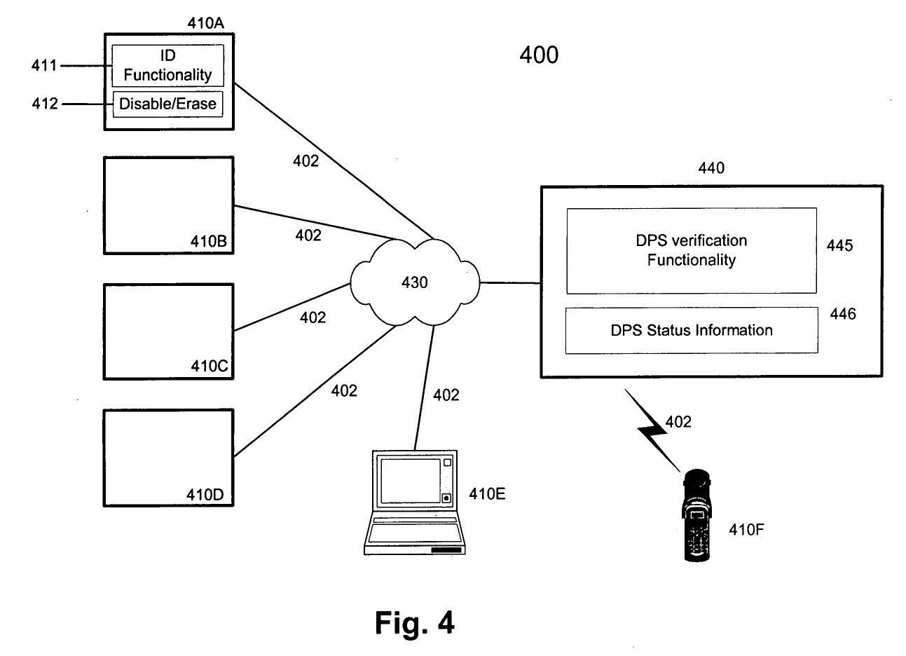

FIG. 4 illustrates a system in which stored data is safeguarded in accordance with one embodiment of the invention. System 400, shown in FIG. 4, includes a number of digital content storage devices, shown for example as digital processing systems (DPSs) 410A-410F. The DPSs 410A-410F may be personal computers, laptop computers, PDAs, or other types of digital processing systems. The DPSs 410A-410F are configured to store and communicate a plurality of various types of data including personal data such as e-mails, audio and video clips and multimedia, for example, as well as documents such as web pages, content stored on web pages, including text, graphics, and audio and video content. For example, the stored content may be audio/video files, such as programs with moving images and sound.

The DPSs 410A-410F contain identification functionality as well as disabling and/or data erasing functionality as discussed above, shown for example as identification functionality 411 and disable/erase functionality 412. The DPSs are capable of communicating with a wireless service provider's operator network DPS 440. For example, operator network DPS 440 is connected via Internet 430 to the DPSs 410A-410E and is connected via a cellular communication system to DPS 410F. The DPSs may communicate with operator network DPS 440 via communication links 402 which direct or indirect links, including but not limited to, broadcasted wireless signals, network communications or the like.

Operator network DPS 440 contains DPS identification verification functionality as well DPS security status information pertaining to DPSs 410A-410F.

For one embodiment of the invention, when one of the DPSs communicates via the communications network, the operator network verifies the identification of the DPS. After the identification of the DPS is verified, the DPS is allowed to access the corresponding security status information stored on the operator network. Based upon the security status information, the DPS executes predefined commands. For example, the user may update the security status information to reflect that the DPS has been lost or stolen. When the DPS accesses the security status information, the DPS may then execute an erase program for some or all of the data stored on the DPS. Alternatively, or additionally, the DPS may execute a disable program.

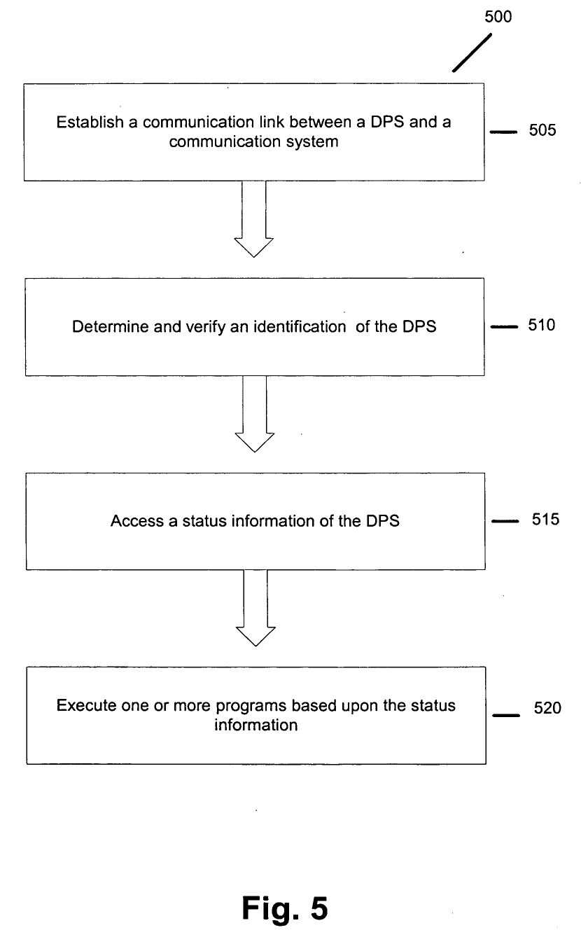

FIG. 5 illustrates a process in which data stored on a data storage device is safeguarded in accordance with one embodiment of the invention. Process 500, shown in FIG. 5, begins at operation 505 in which a communication link is established between a DPS and a communications system. For example, the DPS may access the Internet, or for one embodiment of the invention in which the communications system is a wireless telecommunications system, the DPS may establish a wireless telecommunications link.

At operation 510 the DPS provides an identification that uniquely identifies the DPS which is verified by a operator network DPS of the communication system as discussed above.

At operation 515 the DPS is allowed to access status information pertaining to the DPS system that is stored on the operator network DPS. Such status information may indicate that the DPS has been lost or stolen or that its data integrity has in some way been compromised.

At operation 520, one or more programs (applications), stored on the DPS are executed based upon the status information. For one embodiment of the invention, the operator network DPS communicates a program execution signal to the DPS to effect execution of one or more programs. The program execution signal may be incorporated within the status information and accessing the storage information may cause the operator network DPS to communicate the program execution signal. For one embodiment of the invention, the programs are stored on the DPS and include a disable program to disable the DPS and a data erase program to erase specified data stored in one or more data storage devices of the DPS. For example, if the status information indicates that the DPS has been lost or stolen, the operator network DPS may signal execution of an erase program that erases some or all of the data stored on the DPS. Additionally or alternatively, a disable program may be executed that prevents the DPS from being used.

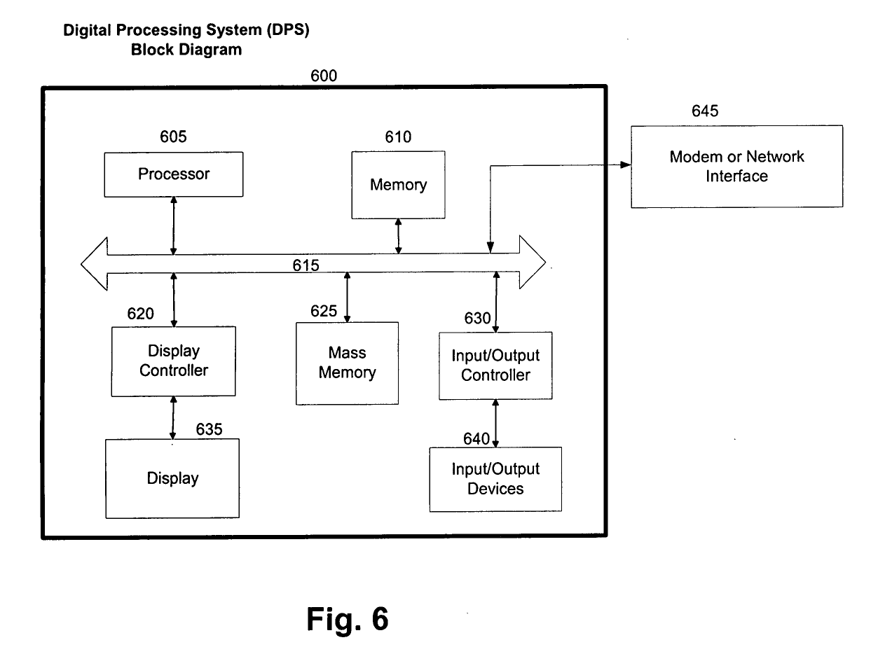

As discussed above, embodiments of the invention may employ DPSs or devices having digital processing capabilities. FIG. 6 illustrates a functional block diagram of a digital processing system that may be used in accordance with one embodiment of the invention. The components of processing system 600, shown in FIG. 6 are exemplary in which one or more components may be omitted or added. For example, one or more memory devices may be utilized for processing system 600. Referring to FIG. 6, the processing system 600, shown in FIG. 6, may be used as a laptop computer, PDA, or other device in which data is stored and which is capable of communicating with a communications system. The processing system 600 may be interfaced to external systems through a network interface or modem 645. The network interface or modem may be considered a part of the processing system 600. The network interface may be a satellite transmission interface, a wireless interface, or other interface(s) for providing a data communication link between two or more processing systems. The processing system 600 includes a processor 605, which may represent one or more processors and may include one or more conventional types of processors, such as Motorola PowerPC processor or Intel Pentium processor, etc. A memory 610 is coupled to the processor 605 by a bus 615. The memory 610 may be a dynamic random access memory (DRAM) an/or may include static RAM (SRAM). The processor 605 may also be coupled to other types of storage areas/memories (e.g. cache, Flash memory, disk, etc.), that could be considered as part of the memory 610 or separate from the memory 610.

The bus 615 further couples the processor 605 to a display controller 620, a mass memory 625 (e.g. a hard disk or other storage which stores all or part of the applications 445 and 446, or 411 and 412 or stored data, depending on the DPS). The network interface or modem 645, and an input/output (I/O) controller 630. The mass memory 625 may represent a magnetic, optical, magneto-optical, tape, and/or other type of machine-readable medium/device for storing information. For example, the mass memory 625 may represent a hard disk, a read-only or writeable optical CD, etc. The display controller 620 controls, in a conventional manner, a display 635, which may represent a cathode ray tube (CRT) display, a liquid crystal display (LCD), a plasma display, or other type of display device. The I/O controller 630 controls I/O device(s) 640, which may include one or more keyboards, mouse/track ball or other pointing devices, magnetic and/or optical disk drives, printers, scalers, digital cameras, microphones, etc.

The processing system 600 represents only one example of a system, which may have many different configurations and architectures and which may be employed in accordance with various embodiments of the invention. For example, various manufacturers provide systems having multiple busses, such as a peripheral bus, a dedicated cache bus, etc. Similarly, a portable communication and data processing system, which may employ a cellular telephone and/or paging capabilities, may be considered a processing system that may be used with an embodiment of the invention. However, such a system may not include one or more I/O devices, such as those described above with reference to I/O device 640.

In the system 600 shown in FIG. 6, the mass memory 625 (and/or the memory 610) may store data that may be processed according to the present invention. For example, the mass memory 625 may contain DPS verification and status information in accordance with one embodiment of the invention. Alternatively, data may be received by the processing system 600, for example, via the network interface or modem 645, and stored and/or presented by the display 635 and/or the I/O device(s) 640. In one embodiment, data may be transmitted across a data communication network, such as a LAN and/or the Internet.

General Matters

Embodiments of the invention include a system that provides the safeguarding of information stored on a DPS capable of communicating with a communications system.

In accordance with one embodiment of the invention when a DPS establishes communication with a communication system, the identification of the DPS is verified and access is provided to security status information pertaining to the DPS. Based upon the security status information, one or more programs are executed on the DPS.

It is an object of one embodiment of the invention to safeguard the private data stored on a data storage device, by permitting the user to erase or destroy that data using an on-air signal. According to one such embodiment of the invention, one or more memory devices of a digital processing system (DPS) may be provided with an erase means. For one embodiment of the invention the erase means comprises a fuse, switch, or similar device in a disable, or erase, circuit. For one embodiment of the invention, the erase means executes an erase command on receiving an on-air erase code which matches an erase code preset by the user. If the DPS is lost or stolen, the user need only establish a communications link with the DPS and enter the erase code to effect erasure (or modification) of specified stored data.

Embodiments of the invention have been described as including various operations. Many of the processes are described in their most basic form, but operations can be added to or deleted from any of the processes without departing from the scope of the invention. For example, for one embodiment of the invention, operation 520 may be extended to include executing a program that provides the operator of the DPS with information regarding the user (e.g., owner) of the DPS. For example, if the status information indicates that the DPS has been lost or stolen, such a user contact program will instruct the operator how to return the DPS to its rightful possessor may be executed prior to disabling the DPS.

Or for example, a program may be executed which downloads specific stored data from the DPS prior to executing an erase program. For example, a user may wish to have specific information retrieved from the DPS prior to the stored data on the DPS being erased. In such an embodiment, a data download program will download specified information, stored on the DPS, to the operator network DPS prior to effecting the erasure of the data stored on the DPS.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
establishing a communication link between a digital processing system and a network operator digital processing system via a communications network;
accessing a status information pertaining to the digital processing system, the status information stored on the network operator digital processing system, the status information indicating whether one or more applications should be executed; and
executing one or more applications as indicated by the status information.

2. The method of claim 1 further comprising:
providing an identification of the digital processing system to the network operator digital processing system prior to accessing the status information.

3. The method of claim 1 wherein the one or more applications include applications selected from the group consisting of a disable application, a data erase application, a data download application, a user contact application and combinations thereof.

4. The method of claim 1 wherein the communication link between the digital processing system and the network operator digital processing system is maintained after execution of the one or more applications.

5. The method of claim 1 wherein the communications network is a wireless telecommunications network.

6. The method of claim 1 wherein the communications network is a communications network selected from the group consisting of an Internet, a wide area network, a local area network, an intranet, and combinations thereof.

7. The method of claim 1 wherein the one or more applications executed comprises a data erase application and the digital processing system contains one or more data storage devices containing data selected from the group consisting of e-mail messages, audio clips, video clips, multimedia, web page content, and combinations thereof.

8. An apparatus comprising:
a network operator digital processing system storing a status information pertaining to the digital processing system, the status information indicating whether one or more applications should be executed; and
a digital processing system configured to establish a communication link via a communications network with the network digital processing system, access the status information and execute one or more applications stored on the digital processing system as indicated by the status information.

9. The apparatus of claim 8 wherein the digital processing system is further configured to provide an identification of the digital processing system to the network operator digital processing system prior to accessing the status information.

10. The apparatus of claim 8 wherein the one or more applications include applications selected from the group consisting of a disable application, a data erase application, a data download application, a user contact application and combinations thereof.

11. The apparatus of claim 8 wherein the communication link between the digital processing system and the network operator digital processing system is maintained after execution of the one or more applications.

12. The apparatus of claim 8 wherein the communications network is a wireless telecommunications network.

13. The apparatus of claim 8 wherein the communications network is a communications network selected from the group consisting of an Internet, a wide area network, a local area network, an intranet, and combinations thereof.

14. The apparatus of claim 8 wherein the one or more applications executed comprises a data erase application and the digital processing system contains one or more data storage devices containing data selected from the group consisting of e-mail messages, audio clips, video clips, multimedia, web page content, and combinations thereof.

15. A machine-readable medium that provides executable instructions, which when executed by a processor, cause the processor to perform a method, the method comprising:
establishing a communication link between a digital processing system and a network operator digital processing system via a communications network;
accessing a status information pertaining to the digital processing system, the status information stored on the network operator digital processing system, the status information indicating whether one or more applications should be executed; and
executing one or more applications as indicated by the status information.

16. The machine-readable medium of claim 15 wherein the method further comprises:
providing an identification of the digital processing system to the network operator digital processing system prior to accessing the status information.

17. The machine-readable medium of claim 15 wherein the one or more applications include applications selected from the group consisting of a disable application, a data erase application, a data download application, a user contact application and combinations thereof.

18. The machine-readable medium of claim 15 wherein the communication link between the digital processing system and the network operator digital processing system is maintained after execution of the one or more applications.

19. The machine-readable medium of claim 15 wherein the communications network is a wireless telecommunications network.

20. The machine-readable medium of claim 15 wherein the communications network is a communications network selected from the group consisting of an Internet, a wide area network, a local area network, an intranet, and combinations thereof.

21. The machine-readable medium of claim 15 wherein the one or more applications executed comprises a data erase application and the digital processing system contains one or more data storage devices containing data selected from the group consisting of e-mail messages, audio clips, video clips, multimedia, web page content, and combinations thereof.
